(19) United States
(12) Patent Application Publication
(10) Pub. No.: US 2023/0269127 A1
(43) Pub. Date: Aug. 24, 2023

(54) INFORMATION PROCESSING DEVICE, INFORMATION PROCESSING METHOD, AND INFORMATION PROCESSING SYSTEM

(71) Applicant: SONY GROUP CORPORATION, TOKYO (JP)

(72) Inventor: KENZOH NISHIKAWA, TOKYO (JP)

(21) Appl. No.: 18/005,109

(22) PCT Filed: Jul. 7, 2021
(86) PCT No.: PCT/JP2021/025618

§ 371 Date: Jan. 11, 2023

(30) Foreign Application Priority Data
Jul. 21, 2020 (JP) 2020-124571

(51) Int. Cl. H04L 41/06; H04B 17/318; H04W 4/38

(52) U.S. Cl. CPC H04L 41/06; H04B 17/318; H04W 4/38

(57) ABSTRACT

The present technology relates to an information processing device, an information processing method, and an information processing system that enable efficient detection of a failure in a sensor terminal.

The information processing device according to the present technology includes a detection unit configured to detect the failure in the terminal on the basis of a result of comparison between a first value and a second value, the first value indicating a relation between a plurality of the terminals each communicating with another terminal, the relation being obtained on the basis of sensor data acquired by a sensor mounted on each of the terminals, the second value indicating a relation between the terminals obtained on the basis of a communication status between the terminals. The present technology is applicable to, for example, an IoT system that collects information from a large number of sensor terminals connected to the Internet to grasp a change in environmental.

### TECHNICAL FIELD

The present technology relates to an information processing device, an information processing method, and an information processing system, and more particularly, to an information processing device, an information processing method, and an information processing system capable of efficiently detecting a failure in a sensor terminal.

### BACKGROUND ART

An Internet of Things (IoT) system that collects information from a large number of sensor terminals connected to the Internet and grasps a change in environment is known. In such a system, the large number of sensor terminals are installed over a wide area, so that a mechanism for detecting a failure in each sensor terminal without human intervention is required.

It is further required that the mechanism for detecting a failure be implemented without increasing power consumed by the sensor terminals and without increasing a processing load and a communication load on a server side.

For example, Patent Document 1 describes a mechanism for causing a failure detection device that acquires, at regular intervals, information regarding communication from each sensor device to detect a failure on the basis of a statistical change in the information regarding communication.

### CITATION LIST

### Patent Document

Patent Document 1: Japanese Patent Application Laid-Open No. 2017-41883

### SUMMARY OF THE INVENTION

### Problems to be Solved by the Invention

In the technology described in Patent Document 1, it is not desirable to transmit, at regular intervals, information to a server that serves as the failure detection device from the viewpoint of power consumed by the sensor terminal. Furthermore, it is not desirable that information is transmitted from the sensor terminal at regular intervals from the viewpoint of a processing load and a communication load on the server.

In a message queueing telemetry transport (MQTT) protocol communication generally used in an IoT system, a sensor terminal transmits a Keep Alive packet to a server at regular intervals. The server confirms that the sensor terminal is working properly on the basis of the reception of the Keep Alive packet and keeps the TCP session alive. Even in a case where the MQTT protocol communication is used, the power consumed by the sensor terminal increases, and the processing load and the communication load on the server increase.

The present technology has been made in view of such circumstances, and an object of the present technology is to enable efficient detection of a failure in a sensor terminal.

### Solutions to Problems

An information processing device according to an aspect of the present technology include a detection unit configured to detect a failure in a terminal on the basis of a result of comparison between a first value and a second value, the first value indicating a relation between a plurality of the terminals each communicating with another terminal, the relation being obtained on the basis of sensor data acquired by a sensor mounted on each of the terminals, the second value indicating a relation between the terminals obtained on the basis of a communication status between the terminals.

An information processing system according to another aspect of the present technology includes: a plurality of terminals each including a sensor, a first communication unit configured to communicate with another terminal, and a second communication unit configured to transmit sensor data acquired by the sensor and information indicating a status of communication with the another terminal; and an information processing device including a detection unit configured to detect a failure in each of the terminals on the basis of a result of comparison between a first value and a second value, the first value indicating a relation between the terminals, the relation being obtained on the basis of the sensor data transmitted from each of the terminals, the second value indicating a relation between the terminals obtained on the basis of a communication status between the terminals.

According to the present technology, on the basis of a result of comparison between a first value and a second value, the first value indicating a relation between a plurality of terminals each communicating with another terminal, the relation being obtained on the basis of sensor data acquired by a sensor mounted on each of the terminals, the second value indicating a relation between the terminals obtained on the basis of a communication status between the terminals, a failure in each of the terminals is detected.

### BRIEF DESCRIPTION OF DRAWINGS

FIG. 1 is a diagram illustrating a configuration example of an information processing system according to an embodiment of the present technology.

FIG. 2 is a diagram illustrating an example of information that is transmitted by a sensor terminal.

FIG. 3 is a diagram illustrating two types of coupling degrees.

FIG. 4 is a diagram illustrating an example of comparison between a beacon coupling degree and a sensor data coupling degree.

FIG. 5 is a diagram illustrating a specific example of a failed sensor terminal.

FIG. 6 is a diagram illustrating a specific example of how to identify a failed part.

FIG. 7 is a diagram illustrating an example of how to identify a failed part on the basis of whether a nearby terminal list has been transmitted or not.

FIG. 8 is a block diagram illustrating a configuration example of the sensor terminal.

FIG. 9 is a block diagram illustrating a configuration example of a server.

FIG. 10 is a flowchart illustrating sensor data transmission processing in the sensor terminal.

FIG. 11 is a flowchart illustrating beacon transmission/reception processing in the sensor terminal.

FIG. 12 is a flowchart illustrating data collection processing in the server.

FIG. 13 is a flowchart illustrating failure detection processing that is performed in step S36 in FIG. 12.

FIG. 14 is a block diagram illustrating a configuration example of hardware of a computer.

### MODE FOR CARRYING OUT THE INVENTION

Hereinafter, modes for carrying out the present technology will be described. Note that the description will be given in the following order.

1. Outline of information processing system

2. Configuration of each device

3. Operation of each device

4. Others

<1. Outline of Information Processing System>

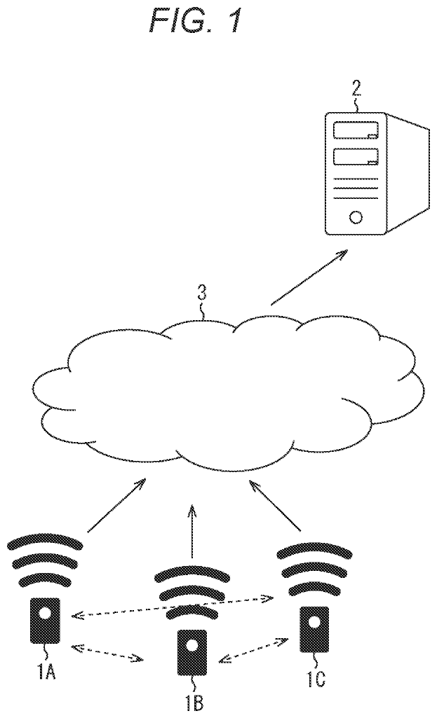

FIG. 1 is a diagram illustrating a configuration example of an information processing system according to an embodiment of the present technology.

The information processing system illustrated in FIG. 1 is, for example, a system that grasps a time-series change in distribution such as temperature or humidity at each installation location on the basis of information acquired by a plurality of sensor terminals installed over a wide area, and performs big data analysis using artificial intelligence (AI). Information obtained as a result of the big data analysis is used for various predictions in fields such as agriculture.

The information processing system includes sensor terminals 1A to 1C and a server 2, the sensor terminals 1A to 1C being connected to the server 2 over a network 3 such as the Internet. For example, the sensor terminals 1A to 1C are connected to the server 2 via mobile communication such as 5G massive machine type communication (5GmMTC).

The sensor terminals 1A to 1C are each a so-called IoT device including one or a plurality of sensors. The sensor terminals 1A to 1C each include at least one of sensors that sense a surrounding environment, such as a camera, a microphone, a temperature sensor, a humidity sensor, a vibration sensor, an optical sensor, and a barometric sensor.

The sensor terminals 1A to 1C each measure a measurement target, and transmit, in a case where there is a measurement result to be transmitted, sensor data indicating the measurement result to the server 2. Causing the sensor data to be transmitted only in a case where there is a measurement result to be transmitted, that is, causing the sensor data to be transmitted at irregular intervals, makes it is possible to reduce a transmission frequency of the sensor data and reduce power consumed by the sensor terminals 1A to 1C.

Furthermore, as indicated by dashed arrows in FIG. 1, the sensor terminals 1A to 1C each transmit and receive a beacon at intervals of 10 minutes, for example. The beacon is transmitted and received via near-field wireless communication using a weak radio wave.

The sensor terminals 1A to 1C each grasp the presence of a nearby sensor terminal by receiving the beacon, and transmit, to the server 2, information indicating a status of communication with the nearby sensor terminal. A sensor terminal capable of transmitting and receiving the beacon, in other words, a sensor terminal within a coverage of the weak radio wave used for transmitting and receiving the beacon is the nearby sensor terminal.

Although three sensor terminals are illustrated in FIG. 1, more sensor terminals are actually installed. Hereinafter, in a case where it is not necessary to identify each of the sensor terminals 1A to 1C, the sensor terminals 1A to 1C are collectively referred to as a sensor terminal 1 as needed.

The server 2 is an information processing device including a computer. The server 2 receives and analyzes the sensor data transmitted from the sensor terminal 1.

The sensor data is transmitted only in a case where there is sensor data to be transmitted, so that the server 2 needs to determine whether a state in which no sensor data is transmitted from the sensor terminal 1 corresponds to a state in which there is no sensor data to be transmitted or a state in which the sensor terminal 1 has failed. Therefore, the server 2 detects a failure in the sensor terminal 1 on the basis of a beacon reception status and the sensor data as follows.

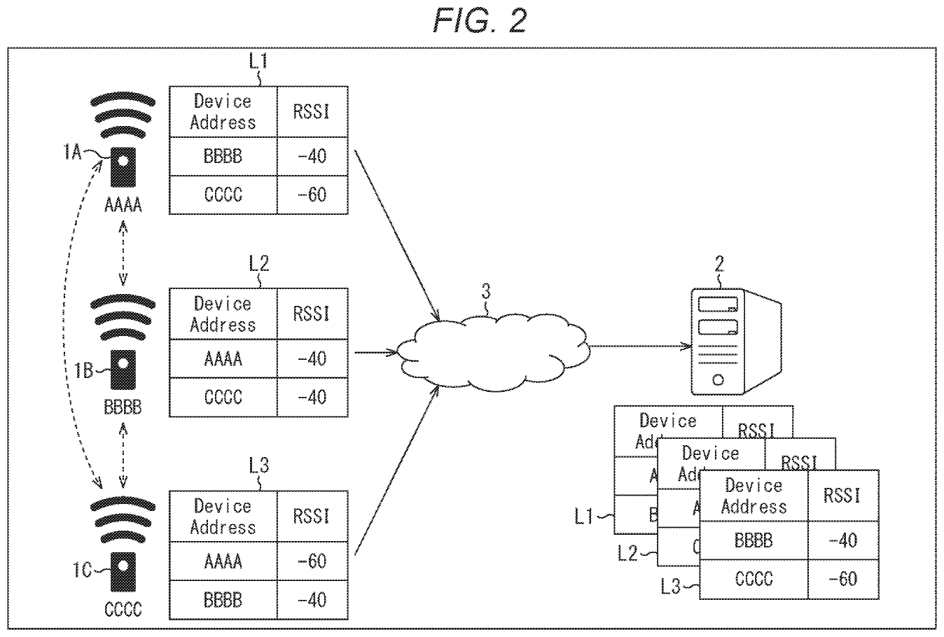

FIG. 2 is a diagram illustrating an example of information that is transmitted by the sensor terminal 1.

As described above, the sensor terminals 1A to 1C each transmit and receive the beacon using the weak radio wave at regular intervals. The beacon includes information that makes each of the sensor terminals 1A to 1C identifiable, such as an ID assigned to each of the sensor terminals 1A to 1C.

The sensor terminal 1 receives the beacon transmitted from another sensor terminal 1 and holds a nearby terminal list. The nearby terminal list is information in which the ID included in the beacon received by the sensor terminal 1 (the ID of the sensor terminal 1 that is a transmission source of the beacon) is associated with information indicating a received signal strength of the beacon. In the example illustrated in FIG. 2, IDs of AAAA, RBBB, CCCC are assigned to the sensor terminals 1A to 1C, respectively.

For example, the sensor terminal 1A receives the beacons transmitted from the sensor terminal 1B and the sensor terminal 1C, and holds a nearby terminal list L1. The nearby terminal list L1 records the fact that the received signal strength of the beacon transmitted from the sensor terminal 1B is −40 as information indicating a status of communication with the sensor terminal 1B. The nearby terminal list L1 further records the fact that the received signal strength of the beacon transmitted from the sensor terminal 1C is −60 as information indicating a status of communication with the sensor terminal 1C.

Similarly, the sensor terminal 1B receives beacons transmitted from the sensor terminal 1A and the sensor terminal 1C, and holds a nearby terminal list L2. The nearby terminal list L2 records information indicating the status of communication with the sensor terminal 1A and information indicating a status of communication with the sensor terminal 1C.

The sensor terminal 1C receives beacons transmitted from the sensor terminal 1A and the sensor terminal 1B, and holds a nearby terminal list L3. The nearby terminal list L3 records information indicating the status of communication with the sensor terminal 1A and information indicating the status of communication with the sensor terminal 1B.

In a case where there is a change in the status of communication with another sensor terminal 1, the sensor terminals 1A to 1C transmit the nearby terminal lists L1 to L3 held by the sensor terminals 1A to 1C to the server 2.

The server 2 receives the nearby terminal lists L1 to L3 transmitted from the sensor terminals 1A to 1C, and obtains a beacon coupling degree on the basis of the nearby terminal lists L1 to L3. The server 2 further obtains a sensor data coupling degree on the basis of the sensor data transmitted from each of the sensor terminals 1A to 1C.

The beacon coupling degree is a value indicating a relation between the sensor terminals 1 obtained on the basis of the nearby terminal lists, that is, on the basis of a beacon transmission and reception status. The sensor data coupling degree is a value indicating a relation between the sensor terminals 1 obtained on the basis of the sensor data.

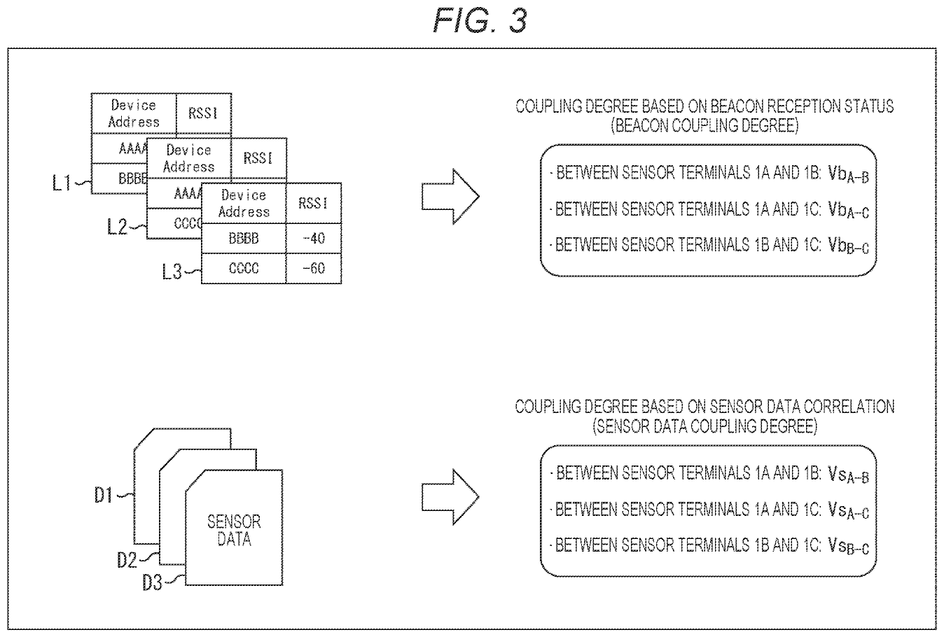

FIG. 3 is a diagram illustrating two types of coupling degrees.

As illustrated in the upper part of FIG. 3, three beacon coupling degrees are obtained on the basis of the nearby terminal lists L1 to L3 transmitted from the sensor terminals 1A to 1C. For example, such a beacon coupling degree is obtained as a value proportional to the received signal strength of the beacon between the sensor terminals 1.

Beacon coupling degrees Vb_{A-B}, Vb_{A-C}, Vb_{B-C} illustrated in FIG. 3 are a beacon coupling degree between the sensor terminal 1A and the sensor terminal 1B, a beacon coupling degree between the sensor terminal 1A and the sensor terminal 1C, and a beacon coupling degree between the sensor terminal 1B and the sensor terminal 1C, respectively.

Furthermore, as illustrated in the lower part of FIG. 3, three sensor data coupling degrees are obtained on the basis of pieces of sensor data D1 to D3 transmitted from the sensor terminals 1A to 1C. The pieces of sensor data D1 to D3 are pieces of sensor data acquired by the sensor terminals 1A to 1C, respectively.

Sensor terminals 1 located near each other measure a nearby environment, so that it is considered that the pieces of sensor data acquired by the sensor terminals 1 located near each other have a strong correlation. The server 2 calculates a degree of correlation between the pieces of sensor data transmitted from the sensor terminals 1, and obtains the sensor data coupling degree as a value proportional to the degree of correlation.

Sensor data coupling degrees VS_{A-B}, VS_{A-C}, Vs_{B-C} illustrated in FIG. 3 are a sensor data coupling degree between the sensor terminal 1A and the sensor terminal 1B, a sensor data coupling degree between the sensor terminal 1A and the sensor terminal 1C, and a sensor data coupling degree between the sensor terminal 1B and the sensor terminal 1C, respectively.

The server 2 compares the beacon coupling degree and the sensor data coupling degree obtained for each pair of the sensor terminals 1.

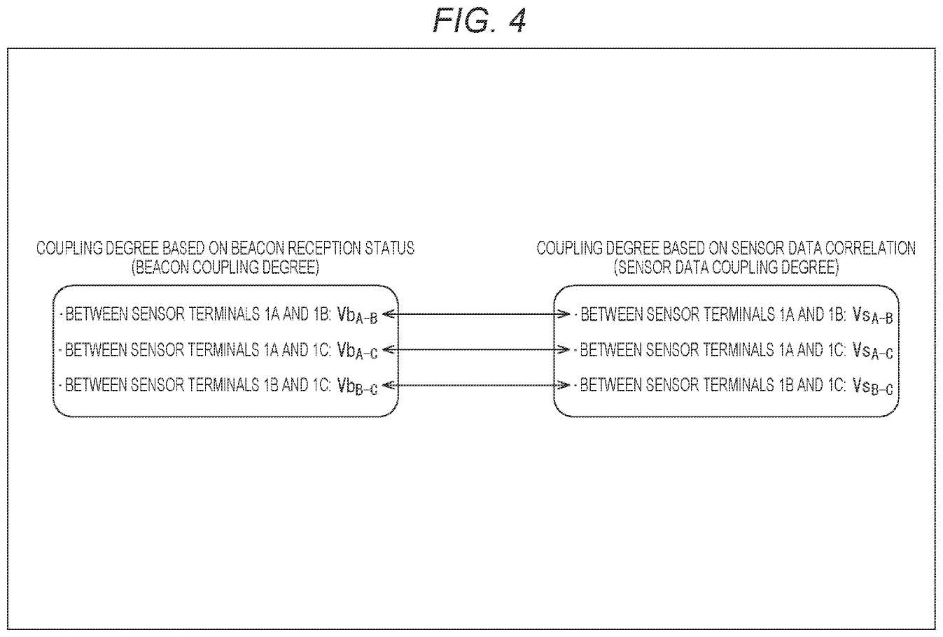

FIG. 4 is a diagram illustrating an example of comparison between the beacon coupling degree and the sensor data coupling degree.

As illustrated in FIG. 4, the beacon coupling degree Vb_{A-B} and the sensor data coupling degree VS_{A-B} indicating the relation between the sensor terminal 1A and the sensor terminal 1B are compared, and the beacon coupling degree Vb_{A-C} and the sensor data coupling degree Vs_{A-C} indicating the relation between the sensor terminal 1A and the sensor terminal 1C are compared. Furthermore, the beacon coupling degree Vb_{A-C} and the sensor data coupling degree Vs_{B-C} indicating the relation between the sensor terminal 1B and the sensor terminal 1C are compared.

The server 2 identifies a failed sensor terminal 1 on the basis of magnitude of a difference between the beacon coupling degree and the sensor data coupling degree.

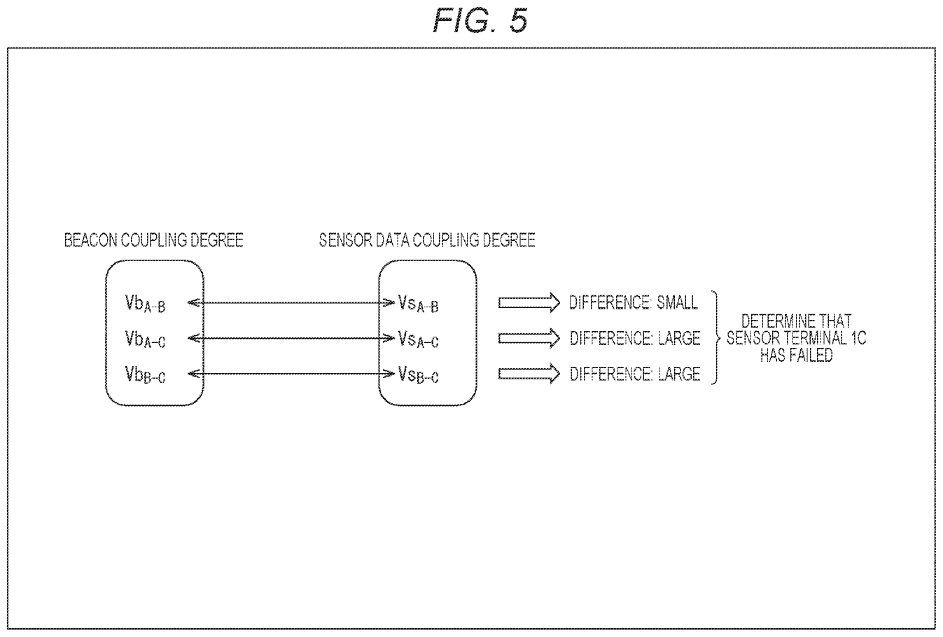

FIG. 5 is a diagram illustrating a specific example of how to identify the failed sensor terminal 1.

In the example illustrated in FIG. 5, a difference between the beacon coupling degree Vb_{A-B} and the sensor data coupling degree Vs_{A-B} is small, and a difference between the beacon coupling degree Vb_{A-C} and the sensor data coupling degree Vs_{A-C} is large. A difference between the beacon coupling degree Vb_{B-C} and the sensor data coupling degree Vs_{B-C} is also large. Whether each difference is large or small is determined on the basis of, for example, a preset threshold.

The server 2 determines that any one of the sensor terminals 1 belonging to a pair that is large in difference between the two types of coupling degrees has failed. In the example illustrated in FIG. 5, the difference between the beacon coupling degree Vb_{A-C} and the sensor data coupling degree Vs_{A-C} indicating the relation between the sensor terminal 1A and the sensor terminal 1C is large, and the difference between the beacon coupling degree Vb_{B-C} and the sensor data coupling degree Vs_{B-C} indicating the relation between the sensor terminal 1B and the sensor terminal 1C is large. The server 2 identifies the sensor terminal 1C belonging to both the pairs as the failed sensor terminal 1.

After identifying the sensor terminal 1C as the failed sensor terminal 1, the server 2 further identifies a failed part of the sensor terminal 1C identified as having failed on the basis of the result of comparison between the beacon coupling degree and the sensor data coupling degree.

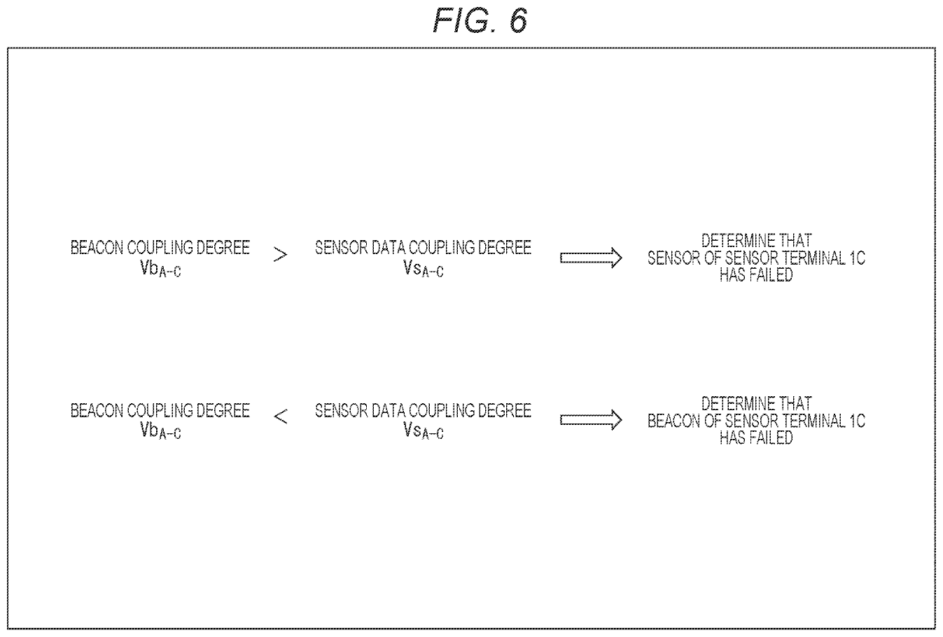

FIG. 6 is a diagram illustrating a specific example of how to identify the failed part.

In a case where a sensor is working properly, it is considered that a sensor data coupling degree equivalent to a beacon coupling degree is obtained on the basis of the sensor data correlation. Therefore, as illustrated in the upper part of FIG. 6, for example, in a case where the sensor data coupling degree VS_{A-C} of the pair including the sensor terminal 1C identified as having failed is smaller than the beacon coupling degree Vb_{A-C}, the server 2 determines that a sensor mounted on the sensor terminal 1C has failed.

Furthermore, in a case where the beacon are being transmitted and received properly, it is considered that a beacon coupling degree equivalent to a sensor data coupling degree is obtained on the basis of the beacon reception status. Therefore, as illustrated in the lower part of FIG. 6, for example, in a case where the beacon coupling degree Vb_{A-C} is smaller than the sensor data coupling degree Vs_{A-C}, the server 2 determines that a beacon transmission/reception unit mounted on the sensor terminal 1C has failed.

The server 2 identifies the failed part of the sensor terminal 1 on the basis of not only the result of comparison between the beacon coupling degree and the sensor data coupling degree but also whether the nearby terminal list has been transmitted or not.

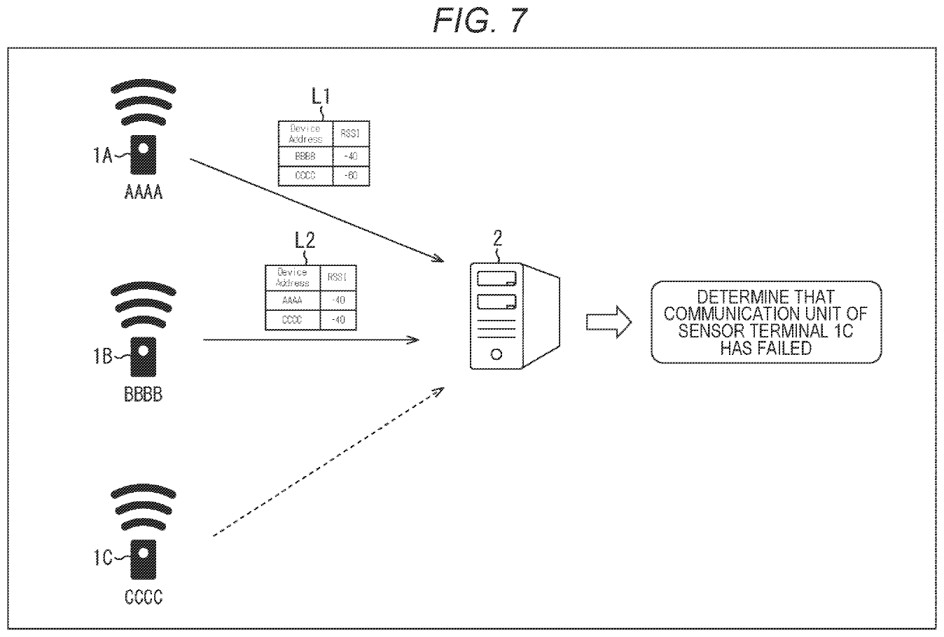

FIG. 7 is a diagram illustrating an example of how to identify the failed part on the basis of whether the nearby terminal list has been transmitted or not.

In a case where the sensor terminals 1A to 1C are located near each other as described above, the nearby terminal list is transmitted from each of the sensor terminals 1A to 1C in response to a change in the beacon reception status.

Nevertheless, as illustrated in FIG. 7, in a case where the nearby terminal list is transmitted only from the sensor terminal 1A and the sensor terminal 1B, and the nearby terminal list is not transmitted from the sensor terminal 1C, the server 2 determines that a communication unit has failed, the communication unit being mounted on the sensor terminal 1C that has not transmitted the nearby terminal list and configured to perform communication with the server 2.

As described above, the server 2 performs processing of detecting the failed part of the sensor terminal 1 on the basis of the result of comparison between the beacon coupling degree obtained on the basis of the nearby terminal list transmitted from the sensor terminal 1 in a case where there is a change in the beacon reception status and the sensor data coupling degree obtained on the basis of the sensor data transmitted from the sensor terminal 1 in a case where there is sensor data to be transmitted.

The sensor terminal 1 performs the regular communication only for the transmission and reception of beacons using the weak radio wave, so that it is possible to reduce the power consumed by the sensor terminal 1.

Furthermore, only in a case where there is a change in the beacon reception status, the nearby terminal list is transmitted to the server 2, and the processing of detecting the failed part is performed, so that the server 2 can reduce a processing load and a communication load required for the processing of detecting the failed part. That is, the server 2 can efficiently detect the failure in the sensor terminal 1.

<2. Configuration of Each Device>

Configuration of Sensor Terminal

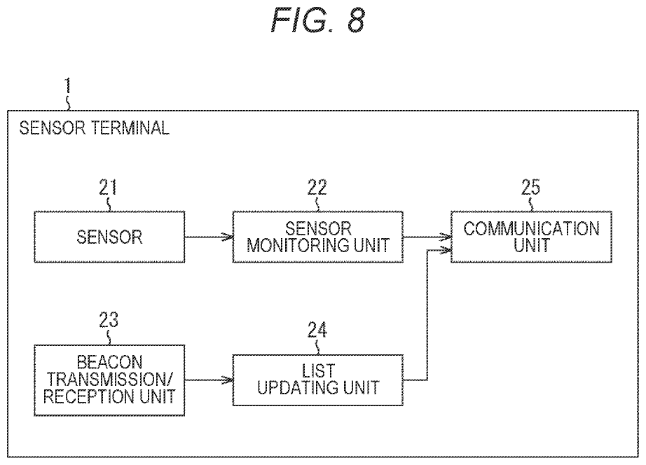

FIG. 8 is a block diagram illustrating a configuration example of the sensor terminal 1.

As illustrated in FIG. 8, the sensor terminal 1 includes a sensor 21, a sensor monitoring unit 22, a beacon transmission/reception unit 23, a list updating unit 24, and a communication unit 25.

The sensor 21 includes the above-described sensor. The sensor 21 measures a target at predetermined intervals, for example, and outputs sensor data indicating a measurement result to the sensor monitoring unit 22.

The sensor monitoring unit 22 monitors the sensor data supplied from the sensor 21. In a case where there is sensor data to be transmitted, the sensor monitoring unit 22 outputs the sensor data to the communication unit 25 to cause the communication unit to transmit the sensor data to the server 2.

The beacon transmission/reception unit 23 transmits and receives the beacon to and from another sensor terminal 1 using a weak radio wave weaker than a radio wave used for communication with the server 2. For example, the beacon transmission/reception unit 23 transmits the beacon at regular intervals using near-field wireless communication such as Bluetooth (registered trademark).

Furthermore, the beacon transmission/reception unit 23 receives the beacon transmitted from another sensor terminal 1, and outputs the ID included in the beacon and information indicating the received signal strength of the beacon to the list updating unit 24.

The list updating unit 24 updates the nearby terminal list on the basis of the information supplied from the beacon transmission/reception unit 23. In a case where there is a change in the beacon reception status, such as a case where there is no beacon from the sensor terminal 1 from which the beacon has been successfully received so far, the list updating unit 24 outputs the nearby terminal list to the communication unit 25 to cause the communication unit 25 to transmit the nearby terminal list to the server 2.

The communication unit 25 performs communication with the server 2 using mobile wireless communication such as 5GmMTC. The communication unit 25 transmits, to the server 2, the sensor data supplied from the sensor monitoring unit 22 and the nearby terminal list supplied from the list updating unit 24.

Configuration of Server

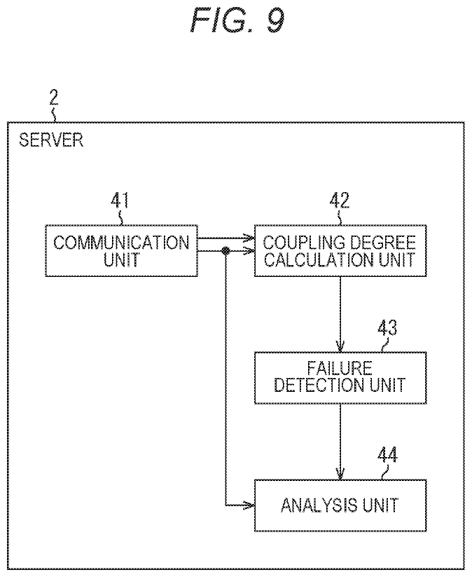

FIG. 9 is a block diagram illustrating a configuration example of the server 2.

As illustrated in FIG. 9, the server 2 includes a communication unit 41, a coupling degree calculation unit 42, a failure detection unit 43, and an analysis unit 44.

The communication unit 41 receives the sensor data transmitted from the sensor terminal 1, and outputs the sensor data to the coupling degree calculation unit 42 and the analysis unit 44. The communication unit 41 further receives the nearby terminal list transmitted from the sensor terminal 1, and outputs the nearby terminal list to the coupling degree calculation unit 42.

The coupling degree calculation unit 42 obtains the sensor data coupling degree on the basis of the degree of correlation between the pieces of sensor data supplied from the communication unit 41. The coupling degree calculation unit 42 further obtains the beacon coupling degree on the basis of the nearby terminal list supplied from the communication unit 41. The sensor data coupling degree and the beacon coupling degree obtained by the coupling degree calculation unit 42 are output to the failure detection unit 43.

The failure detection unit 43 compares the sensor data coupling degree and the beacon coupling degree supplied from the coupling degree calculation unit 42, and detects a failure in the sensor terminal 1 on the basis of the comparison result as described above. The failure detection result from the failure detection unit 43 is output to the analysis unit 44.

The analysis unit 44 analyzes pieces of sensor data acquired by sensor terminals 1 other than the failed sensor terminal 1 on the basis of the failure detection result from the failure detection unit 43. That is, in a case where there is sensor data measured by the sensor terminal 1 determined to be in failure, analysis is performed without the sensor data.

<3. Operation of Each Device>

Here, how each device having the above-described configuration operates will be described.

Operation of Sensor Terminal

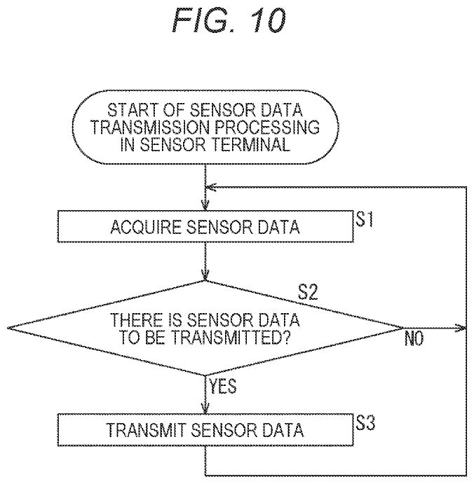

Sensor data transmission processing in the sensor terminal 1 will be described with reference to the flowchart of FIG. 10.

In step S1, the sensor 21 performs measurement and acquires sensor data.

In step S2, the sensor monitoring unit 22 determines whether or not there is sensor data to be transmitted. For example, in a case where there is a change in the sensor data acquired by the sensor 21, it is determined that there is sensor data to be transmitted.

In a case where it is determined in step S2 that there is sensor data to be transmitted, the communication unit 25 transmits the sensor data in step S3. After the transmission of the sensor data, the processing returns to step S1, and the subsequent processing is repeatedly performed.

Similarly, in a case where it is determined in step S2 that there is no sensor data to be transmitted, the processing returns to step S1, and the subsequent processing is repeatedly performed.

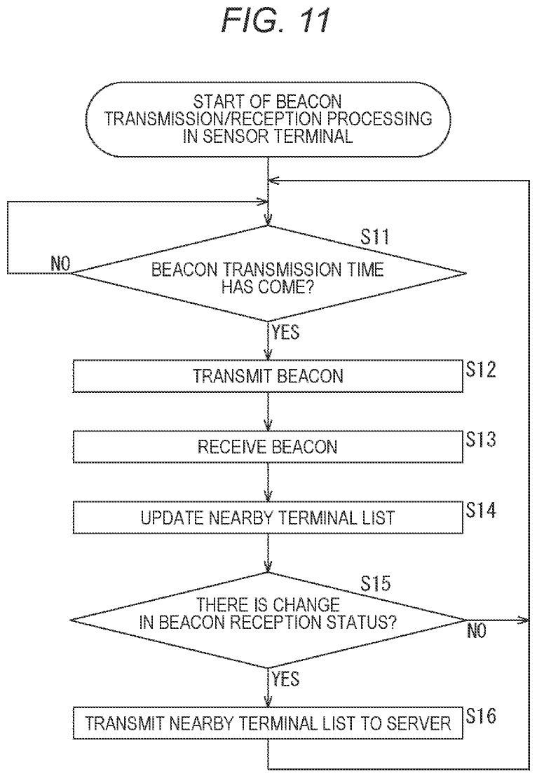

Next, beacon transmission/reception processing in the sensor terminal 1 will be described with reference to a flowchart of FIG. 11. The beacon transmission/reception processing in FIG. 11 is performed in parallel with the sensor data transmission processing described with reference to FIG. 10, for example.

In step S11, the beacon transmission/reception unit 23 determines whether or not a beacon transmission time has come, and waits until it is determined that the beacon transmission time has come.

In a case where it is determined in step S11 that the beacon transmission time has come, the beacon transmission/reception unit 23 transmits the beacon in step S12.

In step S13, the beacon transmission/reception unit 23 receives the beacon transmitted from another sensor terminal 1.

In step S14, the list updating unit 24 updates the nearby terminal list on the basis of the ID included in the beacon received by the beacon transmission/reception unit 23 and the information indicating the received signal strength of the beacon.

In step S15, the list updating unit 24 determines whether or not there is a change in the beacon reception status.

In a case where it is determined in step S15 that there is a change in the beacon reception status, the communication unit 25 transmits the nearby terminal list to the server 2 in step S16. After the transmission of the nearby terminal list, the processing returns to step S1, and the subsequent processing is repeatedly performed.

Similarly, in a case where it is determined in step S15 that there is no change in the beacon reception status, the processing returns to step S1, and the subsequent processing is repeatedly performed.

Operation of Server

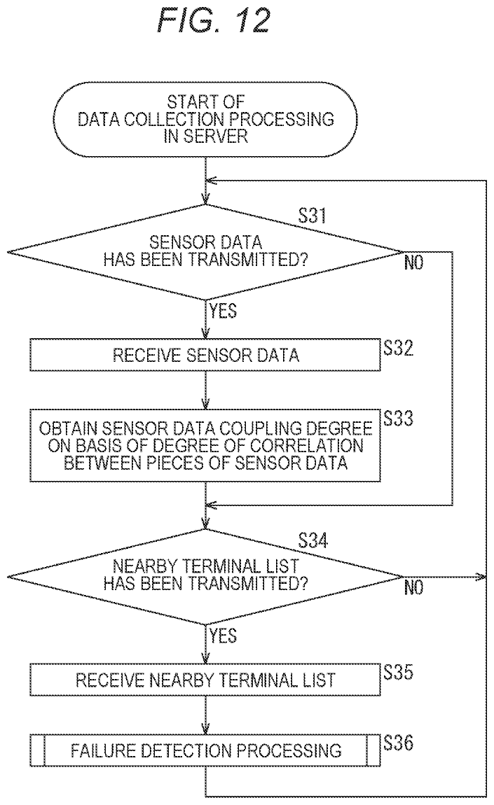

Data collection processing in the server 2 will be described with reference to a flowchart of FIG. 12. In the server 2, it is assumed that sensor terminals 1 located near each other are identified on the basis of the nearby terminal list transmitted before the start of the processing in FIG. 12.

In step S31, the communication unit 41 determines whether the sensor data has been transmitted from the sensor terminal 1 or not.

In a case where it is determined in step S31 that the sensor data has been transmitted, the communication unit 41 receives the sensor data transmitted from the sensor terminal 1 in step S32.

In step S33, the coupling degree calculation unit 42 obtains the sensor data coupling degree on the basis of the degree of correlation between the pieces of sensor data. After the sensor data coupling degree is obtained, the processing proceeds to step S34. On the other hand, in a case where it is determined in step S31 that the sensor data has not been transmitted, steps S32, S33 are skipped.

In step S34, the communication unit 41 determines whether the nearby terminal list has been transmitted from the sensor terminal 1 or not.

In a case where it is determined in step S34 that the nearby terminal list has been transmitted, the communication unit 41 receives the nearby terminal list in step S35.

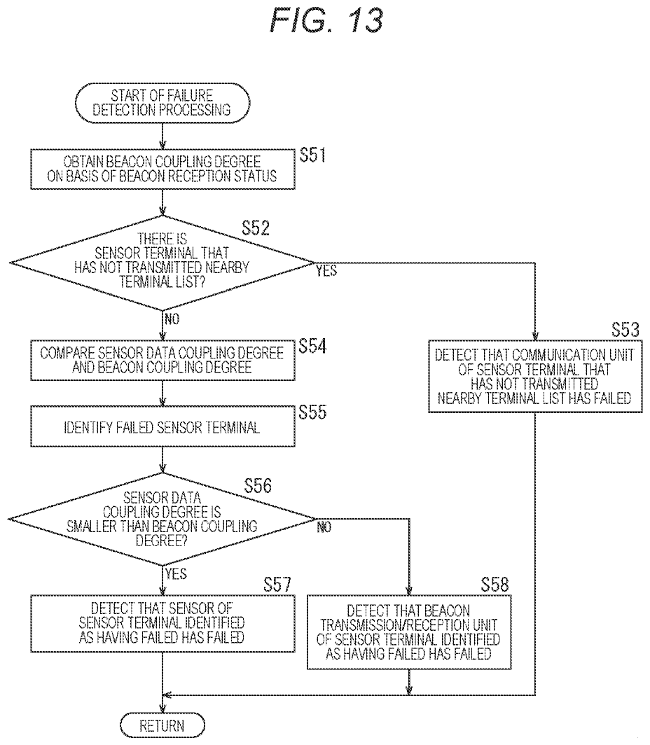

In step S36, the failure detection unit 43 performs failure detection processing. A failure in the sensor terminal 1 is detected by the failure detection processing. Details of the failure detection processing will be described later with reference to FIG. 13. After the end of the failure detection processing, the processing returns to step S31, and the subsequent processing is performed.

On the other hand, also in a case where it is determined in step S36 that the nearby terminal list has not been transmitted, the processing returns to step S31, and the subsequent processing is repeatedly performed.

The analysis unit 44 of the server 2 analyzes the sensor data collected by the data collection processing as described above.

The failure detection processing performed in step S36 in FIG. 12 will be described with reference to the flowchart in FIG. 13.

In step S51, the coupling degree calculation unit 42 obtains the beacon coupling degree on the basis of the nearby terminal list indicating the beacon reception status.

In step S52, the failure detection unit 43 determines whether or not there is a sensor terminal 1 that has not transmitted the nearby terminal list among the sensor terminals 1 located near each other.

In a case where it is determined in step S52 that there is a sensor terminal 1 that has not transmitted the nearby terminal list, the failure detection unit 43 detects that the communication unit 25 of the sensor terminal 1 that has not transmitted the nearby terminal list has failed in step S53.

After the detection that the communication unit 25 of the sensor terminal 1 that has not transmitted the nearby terminal list has failed, the processing returns to step S36 in FIG. 12, and the subsequent processing is performed.

On the other hand, in a case where it is determined in step S52 that there is no sensor terminal 1 that has not transmitted the nearby terminal list, the failure detection unit 43 compares the sensor data coupling degree and the beacon coupling degree in step S54.

In step S55, the failure detection unit 43 identifies, as a failed sensor terminal 1, a sensor terminal 1 belonging to all pairs that are large in difference between the sensor data coupling degree and the beacon coupling degree.

In step S56, the failure detection unit 43 determines whether or not the sensor data coupling degree for the pair including the sensor terminal 1 identified as having failed is smaller than the beacon coupling degree.

In a case where it is determined in step S56 that the sensor data coupling degree is smaller than the beacon coupling degree, the failure detection unit 43 detects that the sensor 21 of the sensor terminal 1 identified as having failed has failed in step S57.

On the other hand, in a case where it is determined in step S56 that the sensor data coupling degree is larger than the beacon coupling degree, the failure detection unit 43 detects that the beacon transmission/reception unit 23 of the sensor terminal 1 identified as having failed has failed in step S58.

After the detection in step S57 that the sensor 21 has failed, or after the detection in step S58 that the beacon transmission/reception unit 23 has failed, the processing returns to step S36 in FIG. 12, and the subsequent processing is performed.

As described above, the server 2 can efficiently detect the failed sensor terminal 1 and the failed part of the sensor terminal 1 on the basis of the beacon coupling degree obtained on the basis of the nearby terminal list and the sensor data coupling degree obtained on the basis of the sensor data while preventing the processing load and power consumption from increasing.

<4. Others>

In the above description, the failure detection processing is performed at the timing when the nearby terminal list is transmitted, but the failure detection processing may be performed at the timing when the sensor data is transmitted. In this case, the server 2 uses a beacon coupling degree obtained in advance and a sensor data coupling degree obtained on the basis of newly transmitted sensor data to identify the sensor terminal 1 that has failed, for example.

Computer

The above-described series of processing may be performed by hardware or software. In a case where the series of processing is performed by software, a program constituting the software is installed from a program recording medium onto a computer incorporated into dedicated hardware, a general-purpose personal computer, or the like.

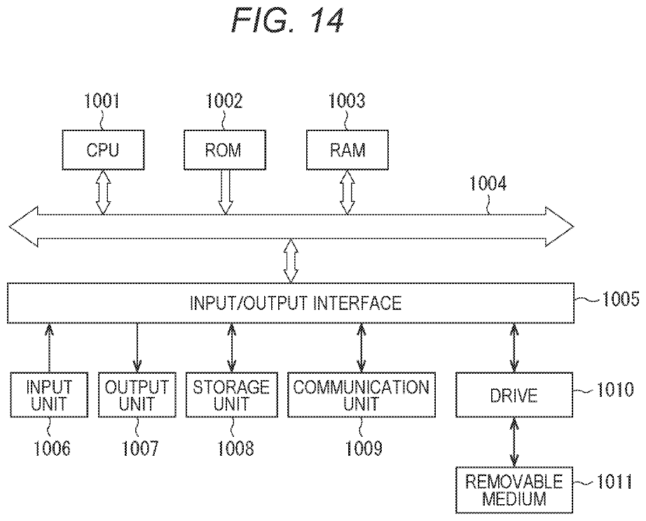

FIG. 14 is a block diagram illustrating a configuration example of hardware of the computer that performs the above-described series of processing in accordance with the program.

A central processing unit (CPU) 1001, a read only memory (ROM) 1002, and a random access memory (RAM) 1003 are mutually connected over a bus 1004.

An input/output interface 1005 is further connected to the bus 1004. An input unit 1006 including a keyboard, a mouse, and the like, and an output unit 1007 including a display, a speaker, and the like are connected to the input/output interface 1005. Furthermore, a storage unit 1008 including a hard disk, a non-volatile memory, or the like, a communication unit 1009 including a network interface or the like, and a drive 1010 that drives a removable medium 1011 are connected to the input/output interface 1005.

In the computer configured as described above, for example, the CPU 1001 performs the above-described series of processing

by loading a program stored in the storage unit 1008 onto the RAM 1003 via the input/output interface 1005 and the bus 1004 and running the program.

The program to be run by the CPU 1001 is provided, for example, using the removable medium 1011 having the program recorded thereon or via a wired or wireless transmission medium such as a local area network, the Internet, or digital broadcasting, and is installed into the storage unit 1008.

Note that the program to be run by the computer may be a program in which the processing is performed in time-series order described herein, or may be a program in which the processing is performed in parallel or at a required timing such as when a corresponding process is called.

Herein, a system means a set of a plurality of components (devices, modules (parts), etc.), regardless of whether or not all the components are in the same housing. Therefore, a plurality of devices housed in separate housings and connected over a network, and one device in which a plurality of modules is housed in one housing are both systems.

Note that the effects described herein are merely examples and are not limited, and other effects may be provided.

The embodiments of the present technology are not limited to the above-described embodiments, and various modifications may be made without departing from the gist of the present technology.

For example, the present technology may have a configuration of cloud computing in which one function is shared and processed in cooperation among a plurality of devices over a network.

Furthermore, each step described in the above-described flowcharts may be performed by one device or may be shared and performed by a plurality of devices.

Moreover, in a case where a plurality of processes is included in one step, the plurality of processes included in the one step may be performed by one device or may be shared and performed by a plurality of devices.

### Example of Combination of Configurations

The present technology may also have the following configurations.

(1)

An information processing device including

a detection unit configured to detect a failure in a terminal on the basis of a result of comparison between a first value and a second value, the first value indicating a relation between a plurality of the terminals each communicating with another terminal, the relation being obtained on the basis of sensor data acquired by a sensor mounted on each of the terminals, the second value indicating a relation between the terminals obtained on the basis of a communication status between the terminals.

(2)

The information processing device according to the above (1), in which

the detection unit identifies a terminal that is larger in difference between the first value and the second value than a threshold as a failed terminal.

(3)

The information processing device according to the above (2), in which

in a case where the first value is smaller than the second value between the failed terminal and the another terminal, the detection unit detects that the sensor mounted on the failed terminal has failed.

(4)

The information processing device according to the above (2) or (3), in which

in a case where the second value is smaller than the first value between the failed terminal and the another terminal, the detection unit detects that a communication unit mounted on the failed terminal and used for communication with the another terminal has failed.

(5)

The information processing device according to any one of the above (1) to (4), further including

a reception unit configured to receive information indicating the communication status between the terminals, the information being transmitted from each of the terminals in response to a change in the communication status between the terminals.

(6)

The information processing device according to the above (5), in which

the detection unit detects that a communication unit has failed, the communication unit being mounted on the terminal that has not transmitted the information indicating the communication status between the terminals and used for communication with the information processing device.

(7)

The information processing device according to the above (5) or (6), in which

the reception unit further receives the sensor data transmitted from the terminal in response to a change in the sensor data.

(8)

The information processing device according to any one of the above (5) to (7), in which

the information indicating the communication status between the terminals indicates a status of communication performed between the terminal and the another terminal using a radio wave weaker than a radio wave used for transmission of the sensor data.

(9)

The information processing device according to the above (8), in which

the communication between the terminal and the another terminal is performed by transmission and reception of a beacon including information that makes the terminal identifiable.

(10)

The information processing device according to the above (9), in which

the information indicating the communication status between the terminals includes the information included in the beacon transmitted from the another terminal and information indicating a received signal strength of the beacon.

(11)

The information processing device according to the above (10), in which

the second value is obtained as a value proportional to the received signal strength of the beacon.

(12)

The information processing device according to any one of the above (1) to (11), in which

the first value is obtained as a value proportional to a degree of correlation between the sensor data acquired by the sensor mounted on the terminal and the sensor data acquired by the sensor mounted on the another terminal.

(13)

The information processing device according to any one of the above (2) to (12), further including

an analysis unit configured to analyze the sensor data acquired by each of the terminals other than the failed terminal.

(14)

An information processing method including

detecting, by an information processing device, a failure in a terminal on the basis of a result of comparison between a first value and a second value, the first value indicating a relation between a plurality of the terminals each communicating with another terminal, the relation being obtained on the basis of sensor data acquired by a sensor mounted on each of the terminals, the second value indicating a relation between the terminals obtained on the basis of a communication status between the terminals.

(15)

An information processing system including:

a plurality of terminals each including:
a sensor;
a first communication unit configured to communicate with another terminal; and
a second communication unit configured to transmit sensor data acquired by the sensor and information indicating a status of communication with the another terminal; and

an information processing device including a detection unit configured to detect a failure in each of the terminals on the basis of a result of comparison between a first value and a second value, the first value indicating a relation between the terminals, the relation being obtained on the basis of the sensor data transmitted from each of the terminals, the second value indicating a relation between the terminals obtained on the basis of a communication status between the terminals.

### REFERENCE SIGNS LIST

1 Sensor terminal
2 Server
21 Sensor
22 Sensor monitoring unit
23 Beacon transmission/reception unit
24 List updating unit
25 Communication unit
41 Communication unit
42 Coupling degree calculation unit
43 Failure detection unit
44 Analysis unit

1. An information processing device comprising
a detection unit configured to detect a failure in a terminal on a basis of a result of comparison between a first value and a second value, the first value indicating a relation between a plurality of the terminals each communicating with another terminal, the relation being obtained on a basis of sensor data acquired by a sensor mounted on each of the terminals, the second value indicating a relation between the terminals obtained on a basis of a communication status between the terminals.

2. The information processing device according to claim 1, wherein
the detection unit identifies a terminal that is larger in difference between the first value and the second value than a threshold as a failed terminal.

3. The information processing device according to claim 2, wherein
in a case where the first value is smaller than the second value between the failed terminal and the another terminal, the detection unit detects that the sensor mounted on the failed terminal has failed.

4. The information processing device according to claim 2, wherein
in a case where the second value is smaller than the first value between the failed terminal and the another terminal, the detection unit detects that a communication unit mounted on the failed terminal and used for communication with the another terminal has failed.

5. The information processing device according to claim 1, further comprising
a reception unit configured to receive information indicating the communication status between the terminals, the information being transmitted from each of the terminals in response to a change in the communication status between the terminals.

6. The information processing device according to claim 5, wherein
the detection unit detects that a communication unit has failed, the communication unit being mounted on the terminal that has not transmitted the information indicating the communication status between the terminals and used for communication with the information processing device.

7. The information processing device according to claim 5, wherein
the reception unit further receives the sensor data transmitted from the terminal in response to a change in the sensor data.

8. The information processing device according to claim 5, wherein
the information indicating the communication status between the terminals indicates a status of communication performed between the terminal and the another terminal using a radio wave weaker than a radio wave used for transmission of the sensor data.

9. The information processing device according to claim 8, wherein
the communication between the terminal and the another terminal is performed by transmission and reception of a beacon including information that makes the terminal identifiable.

10. The information processing device according to claim 9, wherein
the information indicating the communication status between the terminals includes the information included in the beacon transmitted from the another terminal and information indicating a received signal strength of the beacon.

11. The information processing device according to claim 10, wherein
the second value is obtained as a value proportional to the received signal strength of the beacon.

12. The information processing device according to claim 1, wherein
the first value is obtained as a value proportional to a degree of correlation between the sensor data acquired by the sensor mounted on the terminal and the sensor data acquired by the sensor mounted on the another terminal.

13. The information processing device according to claim 2, further comprising
an analysis unit configured to analyze the sensor data acquired by each of the terminals other than the failed terminal.

14. An information processing method comprising
detecting, by an information processing device, a failure in a terminal on a basis of a result of comparison between a first value and a second value, the first value indicating a relation between a plurality of the terminals each communicating with another terminal, the relation being obtained on a basis of sensor data acquired by a sensor mounted on each of the terminals, the second value indicating a relation between the terminals obtained on a basis of a communication status between the terminals.

15. An information processing system comprising:
a plurality of terminals each including:
a sensor;
a first communication unit configured to communicate with another terminal; and
a second communication unit configured to transmit sensor data acquired by the sensor and information indicating a status of communication with the another terminal; and
an information processing device including a detection unit configured to detect a failure in each of the terminals on a basis of a result of comparison between a first value and a second value, the first value indicating a relation between the terminals, the relation being obtained on a basis of the sensor data transmitted from each of the terminals, the second value indicating a relation between the terminals obtained on a basis of a communication status between the terminals.
